(19) United States
(12) Patent Application Publication
(10) Pub. No.: US 2005/0136161 A1
(43) Pub. Date: Jun. 23, 2005

(54) Food freezing and thawing method and apparatus

(76) Inventor: Hideyoshi Okita, Las Vegas, NV (US)

Correspondence Address: ROTHWELL, FIGG, ERNST & MANBECK, P.C., 1425 K STREET, N.W., SUITE 800, WASHINGTON, DC, 20005, US

(21) Appl. No.: 10/743,328

(22) Filed: Dec. 23, 2003

(51) Int. Cl. A23B 4/00

(52) U.S. Cl. 426/393

(57) ABSTRACT

A method of freezing food for later thawing and use which includes the steps of packing a food product in a container for freezing, cooling the food substantially throughout the bulk thereof to about 10° C. and then cooling the food substantially throughout the bulk thereof preferably from about 10° C. to about −10° C. in approximately 10 minutes to less than approximately 40 minutes.

### BACKGROUND OF THE INVENTION

1. Field of the Invention

This invention generally pertains to systems and methods for freezing and for thawing food. More particularly, the present invention is directed to systems and methods of freezing food products that minimize damage to the food, such as aging, that may occur during the freezing process. The present invention also relates to systems and methods for thawing frozen foods to maximize taste.

2. Description of the Related Art

In conventional prior art freezing methods, food is reduced in temperature from room temperature to the frozen state in a matter of hours, typically 1 to 3 hours. When such conventional methods are applied to high water content foods such as sushi (which is a well known combination of cooked rice, raw fish and other toppings), a substantial portion of the water in the food is irreversibly lost. The loss of water is caused by an accelerated aging process that takes place when the food is exposed to a certain temperature zone for a relatively long period of time during conventional freezing processes. Exposure to this accelerated aging temperature zone for prolonged periods of time also results in the generation of ice crystals at a high rate. As a result, ice crystals that form will expand in size with time and rupture the cell structure of the food being frozen. When the food is defrosted, water generated from the ice crystals will be irreversibly lost from the food. Thus, conventional prior art food freezing methods have substantial drawbacks resulting from the substantial loss of moisture content, cell structure damage, thereby reducing freshness and changing the texture and desirability of the thawed food product.

In connection with efforts to improve conventional prior art freezing methods, many professional and industrial “quick” freezer systems use low temperature nitrogen gas or carbon dioxide gas as a cooling medium for more rapid (flash) freezing purposes. While nitrogen gas has a low temperature capability (−196° C.), its specific heat is only about 47 Kcal/gram/° C., and therefore is not sufficient in terms of heat absorption capacity to extract heat from the bulk of the food at high rates. While conventional freezers create fractured food cells due to ice crystal growth, quick freezer systems utilizing low calorie cooling sources may damage food cells due to rapid freezing of the food. In both cases, food cells are destroyed during the freezing process. Carbon dioxide gas has a higher specific heat than nitrogen gas (about 137 Kcal/gram/° C.), but has a much higher minimum temperature (about −79° C.). Quick freezing systems using carbon dioxide gas encounter the same problems with high water content foods as described above.

In another attempt to address shortcomings with conventional freezing techniques, it has been proposed to apply a magnetic field to the food during the freezing process. In this approach, according to U.S. Pat. No. 6,250,087, magnetic energy is applied to the food to be frozen in a conventional freezer to attempt to prevent cell fracture caused by ice crystal growth during the freezing process. The food is shaken by the application of the magnetic field to suppress crystallization. However, this approach uses conventional freezing technology and the process still takes a long time for complete freezing to take place (2 to 3 hours). While it is asserted that this approach maintains moisture in the cell and prevents dripping, such systems are complex, expensive, and have limited capacity.

For the foregoing reasons, there is a need for new and improved systems and methods for freezing and thawing food. The present invention overcomes these and other problems that occur with convention freezing techniques, and particularly in connection with freezing of higher water content foods.

### SUMMARY OF THE INVENTION

In accordance with the foregoing and other objects, the present invention provides a method of freezing food-for later thawing and use. The method includes the steps of packing a food product in a container for freezing, cooling the food product substantially throughout the bulk thereof to about 10° C., and then cooling the food product substantially throughout the bulk thereof from about 10° C. to about 0° C. in less than approximately ten minutes.

According to another embodiment of the present invention, a method of freezing a food product is provided which includes a step of packaging a food product to be frozen after the temperature of the food product reaches a first predetermined temperature. The food product is then cooled until the temperature of the food product reaches a second predetermined temperature. The food product is then cooled so that the temperature of the food product decreases from the second predetermined temperature to a third predetermined temperature within a first predetermined period of time.

According to another embodiment of the present invention, a system for freezing a food product is provided which comprises a freezer and a control unit. The freezer maintains an interior temperature set to a first temperature and includes a first cooling unit and an adjustable cooling unit providing additional cooling energy. The control unit is coupled with the adjustable cooling unit and configured to adjust the additional cooling energy. The adjustable cooling unit provides additional cooling energy on demand.

According to the present invention, the calorie exchange rate of the freezer is adjusted to obtain the optimal freezing process to maintain the original taste and texture of the food. High water content foods, such as rice, can be frozen in a short period of time and in a manner that captures water in a food cell before large ice crystal clusters form and grow.

According to one embodiment of the present invention, dry ice is used as a cooling source in a double freezer configuration. When dry ice changes from its solid state to gas phase directly, a much higher calorie exchange rate is produced than when liquid carbon dioxide changes phase to gas. The present invention is a simple, low cost system suitable to freeze a large capacity of food. Also, the simple design of the present invention includes a continuous frozen food chamber that enables almost unlimited production of frozen foods.

According to another embodiment of the present invention, a method of thawing frozen food is provided which comprises the steps of placing a container of coolant on a side of the frozen food, and steaming the frozen food from a side that is opposite to the side where the container of coolant is placed. The food is steamed until the food is thawed to a desired temperature.

According to the present invention, food is preferably frozen in a reasonably short period of time to avoid exposing the food to the maximum ice crystal generation zone for extended periods of time which will cause damaging food by ice crystal growth. This is accomplished by using a high calorie cooling source, such as, for example dry ice. The freezing process of the present invention avoids the dehydration phenomenon resulting from conventional, quick freezing methods.

According to the present invention, a method is provided for thawing frozen food which includes a step of arranging a plurality of containers of frozen food in a tray. A package of coolant is placed on a side of each of said frozen food. A source of warm water is supplied to the tray until the plurality of containers of frozen food is thawed to a desired temperature.

With these and other objects, advantages and features of the invention that may become hereinafter apparent, the nature of the invention may be more clearly understood by reference to the following detailed description of the invention, the appended claims, and the drawings attached hereto.

### BRIEF DESCRIPTION OF THE DRAWINGS

The invention will be described in detail with reference to the following drawings, in which like features are represented by common reference numbers and in which:

FIG. 1A is a block diagram of a system for freezing food according to an embodiment of the present invention;

FIG. 1B is a block diagram of a system for freezing food according to another embodiment of the present invention;

FIG. 2A-2B are side and top views of a tunnel type freezer according to another embodiment of the present invention;

FIG. 2C is a cross sectional partial side view of a tunnel type freezer according to the embodiment in FIGS. 2A and 2B;

FIG. 3 is a diagram showing a number of temperature sensors within the interior freezer;

FIG. 4 is a chart showing temperature versus time curves for freezing or thawing food;

FIG. 5 is a flow diagram of a method for freezing food according to an embodiment of the present invention;

FIG. 6 is a diagram of a system for thawing food according to an embodiment of the present invention;

FIGS. 7A and 7B are illustrations of containers used in connection with the system for thawing foods according to the system of FIG. 6; and

FIGS. 8A-8C are illustrations of a system for thawing a large volume of containers of frozen foods according to an embodiment of the present invention.

FIGS. 9 is an illustration of a system for thawing a large volume of containers of frozen foods according to another embodiment of the present invention.

### DETAILED DESCRIPTION OF THE PREFERRED EMBODIMENT

Although the present invention is applicable to the freezing and thawing of foods, and particularly those foods having high moisture content, the present invention will be described in connection with a preferred embodiment directed to freezing and thawing the food product sushi.

In accordance with the present invention, sushi refers to any food product known as sushi such as, for example, a food product in the form of cooked rice with some form of topping (e.g., fish, avocado, etc.). Sushi can also be in the form of rolls. Sushi typically has a moisture content of about 60% by weight. There are several important factors to be considered when freezing high water content food which is intended to be defrosted later for consumption. One factor is the aging process by which foods like rice can irreversibly lose their water content. In the case of sushi, this is a process by which a molecular chain of starch loses its regular array and turns into paste. The aging process in sushi is accelerated when the food is reduced to approximately below 10° C. and is most severe through a temperature range of about 6° C. to about 0° C. This temperature zone is referred to as the “accelerated aging temperature zone.”

A second factor is referred to as “the maximum ice crystal generation zone,” during which the water within the food forms into ice crystals. This occurs, in the case of sushi, in the range of from approximately 0° C. down to approximately −4 to −10° C. In this temperature zone, approximately 75% or more of the water in the food is transformed into ice crystals. The ice crystals damage the food during formulation by destroying cell structure, drying, etc. The present invention controls the freezing process to ensure that food is passed through those two temperature zones in the desired time, but also ensures that the freezing occurs throughout the bulk of the food as well.

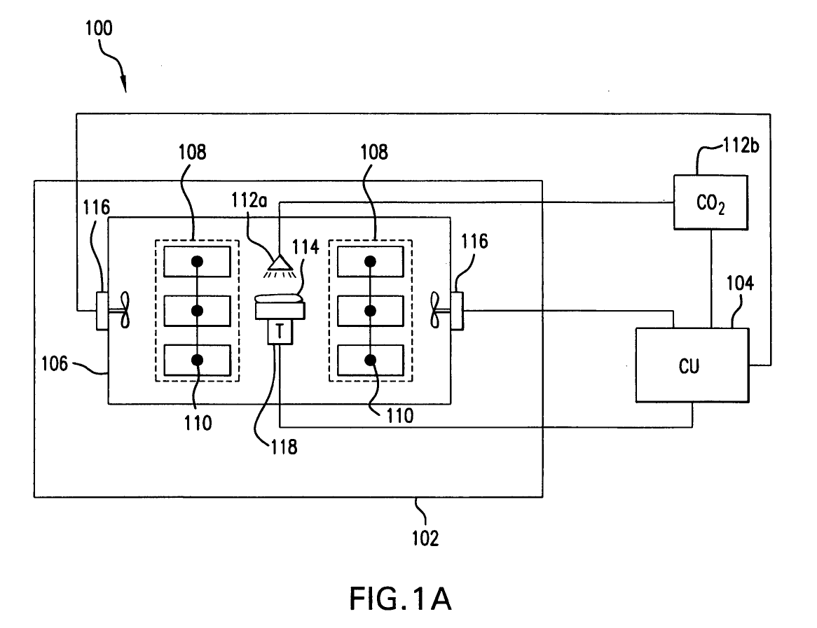

FIG. 1A is a block diagram of a food freezing apparatus according to an embodiment of the present invention. Freezing apparatus 100 includes a first freezer 102, a control unit 104, and a second freezer 106 contained within the interior of first freezer 102. The first and second freezers may be any commercially available freezers which are capable of performing in accordance with this disclosure and are not meant to be limited except as expressly provided herein.

Second freezer 106 includes one or more cooling units 108 which comprise a high calorie cooling source such as, for example, dry ice blocks. Dry ice may be provided in racks, as shown in FIG. 1B. The second freezer 106 further includes one or more variable cooling source discharge nozzles 112a which, in a preferred embodiment, discharge liquid CO₂ as a cooling source. Variable cooling source nozzles 112a are preferably connected to a variable cooling source 112b, which is connected to control unit 104. The second freezer 106 also preferably includes one or more air circulation units or mechanisms 116, such as fans, for circulating the air within the second freezer thereby causing cooling by convection as well as conduction.

The system 100 may also include one or more cooling unit adjustment mechanisms 110 that adjust the cooling units 108 to provide more or less heat transfer (cooling) energy to the food 114 as needed depending on the size of the dry ice cluster and the volume of the food in the freezer. In one embodiment, the cooling adjustment mechanism is a rod or bar which is connected to each of the cooling units 108 so that those units can be moved or rotated in unison. For example, if cooling units 108 include dry ice blocks, then the adjustment unit 110 is preferably used to change the angle of the blocks relative to the circulation units 116 to increase or decrease heat transfer from the dry ice blocks to the food 114 by providing more or less surface area of dry ice in contact with circulating air. The adjustment mechanism 110 can be used in connection with the manual adjustment of the cooling units 108. In another embodiment, adjustment mechanism 110 can be used in connection with an automated adjustment of the-cooling units 108. In this embodiment, electronic movement of the adjustment mechanism and cooling units is controlled by the control unit 104.

The dual-freezer configuration of the present invention provides a very stable reference cooling temperature in the interior freezer 106. One skilled in the art will understand that single freezer arrangements can also be used. In single freezer arrangements, various loading systems may be used to prevent loss in cooling energy during loading and unloading of food to be frozen, in order to maintain a steady interior temperature of the freezer. For example, suitable loading systems could include a loading chamber unit attached to a freezer with a door on the loading side and another door on the freezer side with an air tight seal. During the loading process, a door on the loading side is open, but the door on the freezer side remains closed. Once the food rack is loaded into the loading chamber, a door on the loading side is closed first and then the door on the freezer side is open to allow the food rack to enter inside of the freezer. When the food is completely frozen as described in the detailed description of the invention, the food rack is preferably taken out in the reverse order as described in connection with the loading process.

The thermal exchange with the food to be frozen can be performed smoothly using a high calorie cooling unit, such as dry ice, which has a very high calorie heat transfer coefficient. Food placed inside the second freezer 106 can have its temperature passed through the accelerated aging temperature zone and maximum ice crystal generation zone within a short period time by using a high calorie cooling source.

The control unit 104 is coupled to the adjustment unit 110, variable cooling source 112b and circulation means 116, as well as to one or more temperature sensors 118 which measure the temperature of the interior of freezer 106 and/or of the food 114. The control unit 104 may include a computer processor or the like, a memory unit and appropriate input/output devices (not shown) for communicating with and controlling adjustment unit 110, variable cooling source 112b and circulation means 116, and for receiving temperature data from the one or more temperature sensors 118. The control unit is preferably programmed with computer software for facilitating the processes of the present invention, which are described in more detail below.

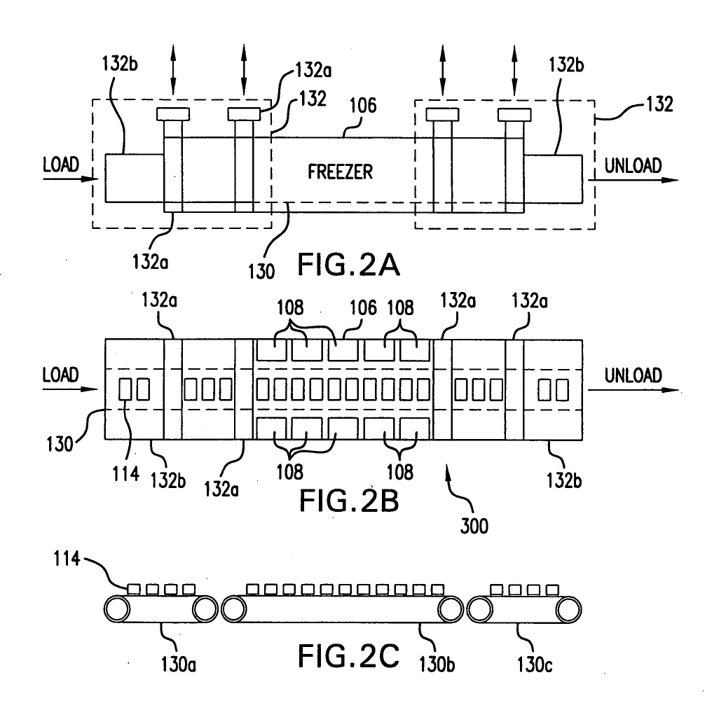

FIG. 1B is a block diagram of freezing apparatus 200 according to another embodiment of the present invention. As shown, freezing apparatus 200 contains a freezer 206. Freezer 206 preferably contains one or more cooling units 108. Cooling units 108 preferably are racks containing a cooling source such as, for example, dry ice blocks. One or more fans 116 are disposed along the walls of freezer 206 in position to circulate air over the dry ice racks 108 toward the food to be frozen 114, which also is disposed in a suitable food rack 119. The motors for the fans 116 are sealed in the wall to reduce heat transfer from the motors to the interior of the freezer 206. A CO₂ gas nozzle 112a is provided near the food rack 119 which supplies variable cooling when necessary. The control unit 104 is coupled to the fans 116, CO₂ source 112b, and a thermocouple (as illustrated in FIG. 3) inserted into an item of food (e.g., sushi). The control unit is configured to control the fans 116 and CO₂ source 112b to adjust the level of cooling energy depending upon the temperature of the food, and to cool the food as defined by the present invention. Freezer 206 may be used as the second, interior freezer in the dual freezer embodiment in FIG. 1A or may be used as the single freezer in a single freezer configuration of the present invention

The size of freezer in accordance with the present invention can be of any suitable size depending on the quantity of food to be frozen. In one embodiment, freezer 206 is approximately 8′×8′×8′ and can be used to freeze approximately two to three 200 pound batches of sushi according to the present invention. In this embodiment, approximately 400 pounds of dry ice is placed in racks 108. Also, the freezers are preferably capable of maintaining a positive air pressure inside of approximately 5 psi to maintain the dry ice and to allow the dry ice to sublimate properly for the desired cooling. To maintain the pressure, a pressure relief valve (not shown) may be provided to vent the freezer when necessary if the pressure is increasing.

The temperature sensors 118 may also be placed in the vicinity of the food 114 or any other location within freezers 106 and 206 to allow proper monitoring thereof. For example, as shown in FIG. 3, a temperature sensor 18a may be mounted in the interior of freezers 106 and 206 to measure the temperature of the freezer environment. FIG. 1 illustrates an example of mounting the temperature sensor 118a in the interior of freezer 106. Also, as shown in FIG. 3, a temperature sensor 118b is preferably connected inside the food product 114 to monitor the interior temperature of that food product. Temperature sensors 118a and 118b are preferably connected to the control unit 104 so that the interior and core food temperatures can be monitored and controlled. As illustrated in FIG. 3, the temperatures are preferably displayed on a monitor.

In another embodiment of the present invention, a temperature sensor is positioned to measure the surface temperature food product. The surface temperature of the food produce, which largely corresponds to the temperature of the interior of the freezer, may be used to provide additional information for freezing food products in accordance with the present invention.

The control unit 104 is configured to control the speed of the circulation of air over the dry ice. Also, control unit 104 may control the interior temperature of the freezer 106, including the variable cooling source 112a and 112b as needed to ensure that the food 114 is cooled at the proper rate. For example, if the temperature of food to be frozen is not decreasing at the desired rate, the variable cooling may be initiated to further reduce the temperature inside second freezer 106 or freezer 206 at the desired rate. The control unit 104 also may reduce or terminate the variable cooling to prevent the outside region of the food from cooling too quickly so that the food is frozen throughout its bulk properly. For example, carbon dioxide gas may be discharged into second freezer 106 or freezer 206 via nozzle 112a for a predetermined amount of time (e.g., a few seconds), or until the environment or food (surface and/or core) reaches a selected temperature.

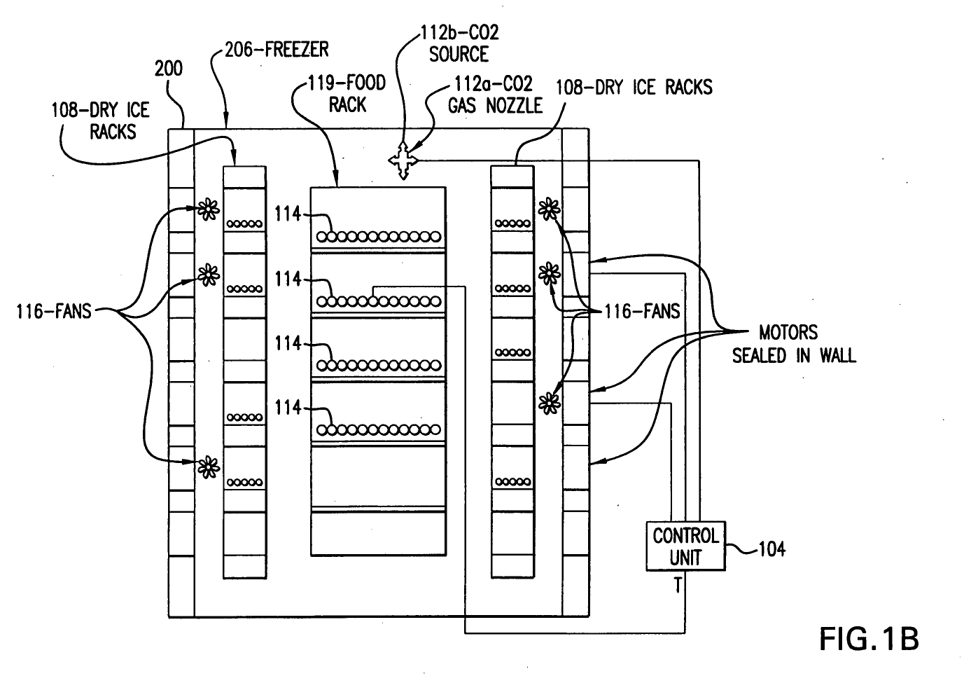

In another embodiment of the present invention, the freezer system may be configured for continuous high volume operation by providing conveyor mechanism or the like for loading and unloading units of food to be frozen. One example of a continuously operating freezer 300 is shown in FIGS. 2A-2B.

FIG. 2A is a side view and FIG. 2B is a top view of an exemplary “tunnel” style freezer 300 according to one embodiment of the present invention. In the tunnel style freezer 300, a conveyor belt assembly 130, which may include one or more conveyor belts, can be provided for continuous delivery of foods to be frozen. To accommodate the conveyor belt 130, a load lock means 132 may be included to maintain temperature inside the freezer 106 and prevent loss of cooling energy during loading and unloading. For example, the conveyor belt assembly 130 preferably includes three conveyor belt sections 130a, 130b and 130c, one on each side of the freezer 106 and one inside freezer 106 as illustrated in FIG. 2C. Each load lock means 132 may include two doors 132a, an exterior door (loading/unloading gates) and an interior door (loading/unloading lock gates), and a loading/unloading section or housing 132b. The doors 132a may open and close rapidly to allow batches to enter and exit the freezer 106 and can be configured to prevent loss of cooling energy to the freezer 106. For example, the exterior doors 132a may not open unless the interior doors 132a are shut, and vice versa.

Referring to FIG. 2B, the conveyor belt may pass between the dry ice racks 108, and the rest of the freezer 106 configuration may remain the same as the embodiments already described above in connection with FIGS. 1A-1B. In this configuration, temperature sensors may be permanently disposed within the interior of freezer 106, or wireless sensors are contemplated that could be inserted into the food before freezing and removed thereafter.

In a preferred embodiment, the food products to be frozen, such as sushi, should first be packaged into a container, such as a bag, and hermetically sealed after de-aeration. Such packaging locks flavor into the product and helps prevent the food from drying. Shrink wrapping or vacuum bagging the food allows good results and is preferred.

Operational aspects of the present invention are discussed in connection with a discussion of the temperature characteristics of the environment of the interior of the second freezer 106 and of the food during freezing. For example, in an experiment, an arbitrary volume of cooked rice (2 lbs) was cooled to room temperature (about 22° C.) and stored in a bag after it was determined to be in a balanced condition. The package was de-aerated and sealed. The food was then stored in the interior of freezer 106 maintained at a temperature of −60 to −70° C. Temperature sensors were used to measure (1) the environment or reference temperature of the interior space of second freezer 106, and (2) the core temperature of the food 114.

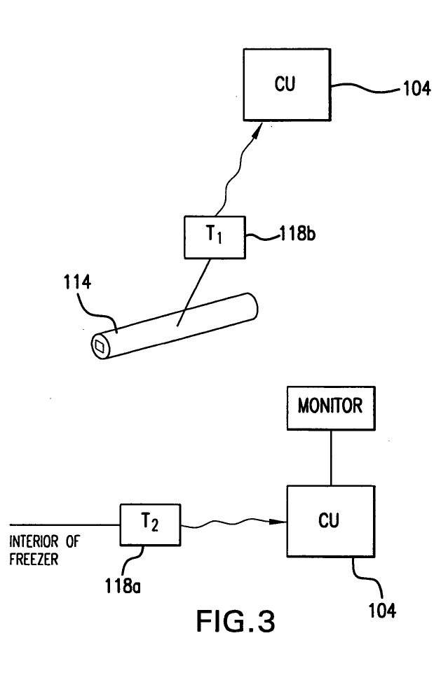

The results of the experiment are shown in FIG. 4 Curve A is the cooling transmission rate curve of the temperature inside the interior of freezer 106. Curve B shows the temperature of the core of the food to be frozen.

Curve A reflects the measured interior environment temperature of freezer 106, which also reflects the cooling capacity of the freezer. The interior environment temperature A of the freezer changes as a function of time because of thermal energy exchange using the air in the freezer as a catalyst. In other words, the environment temperature A shows the transition in the freezer caused by thermal transmission from the outside surface of food product, such as a rice cluster, which is warmer than the environment temperature, as air passes over the food product. This temperature inclination changes the degree of the angle by the freezer capability per unit of a chiller source, wind velocity and size of transfer surface area, etc., however it can be read that the change of inclination has a general tendency which is affected by the thermal capacity of the rice cluster.

Cooling control of the freezer can be determined from the curves, such as the curves represented in FIG. 4. When curve B reaches the maximum ice crystal generation zone, it can be observed that the angle of curve A begins to flatten, which indicates the lack of heat transmission energy of the freezer 106. If this is detected, a cooling control will be applied to increase transmission energy.

The freezing activity is achieved by seeking the phase inversion, by passing the temperature of the food through its freezing point artificially. A complex group of solid-state properties has many different freezing points, especially food which is a complex of hydrous substances, like sushi, the ingredients of which may have significantly different water characteristics to be carefully treated. Since curve A is the curve of the controllable buffer zone in a cooling process, it shall be considered as a control region such that the cooling heat energy, the transmission speed for the heat exchange, etc. and cooling transmission temperature control should be applied within this zone.

Curve B is considered as the cooling heat conduction area of the rice cluster by which the cooling heat transmission is undertaken, and it should be understood as an analytical area for a proper control of the hydrous properties of the food. That is, from curve B, it can be determined how to adjust the cooling within the freezer 106, as more or less energy is required to achieve the desired cooling of the food.

It can be observed that curve B has a shallow angle as the temperature goes below 0° C. and continues until a point where curve B reaches approximately −10° C. From this observation, it can be understood that the heat conduction ratio of the food reduces following the progression of ice precipitation in the food between the surface and the core of the food due to ice precipitation of menstruum (free water) at the surface of a rice cluster. Also, each rice grain is individually affected by the changes in the thermal conductivity from the outside to the core of the rice cluster, and it is therefore understood that curve B reflects the heat exchange rate of the area between the surface and the core of the food as the aggregate of average complicated heat flow speed.

Curve B also shows the similar tendency as curve A. However, while curve A corresponds to a transmission rate with comparatively high efficiency by the direct heat dissipation transfer to the environment temperature, curve B shows a widening temperature difference from curve A by relaying to the layer where the conduction efficiency is low in the progression of heat flux process from the curve A, and in spite of the rapid declining angle of curve A, continues as being indicated an aspect of passing through a temperature zone of the specific food. Meanwhile, each layer from the exterior side to the core side of the food advances mainly the phase changes of free water and relay descent in the direction where the constituent is frozen, and the temperature thereof passes through the maximum ice crystal generation zone.

At this stage, curve B shifts to the steep angle. The difference between the temperatures of core side and the exterior side becomes narrow and finally, overlap each other, and the thermal conductivity of the each layer of rice cluster become almost equivalent, and the freezing is deepened in proportion to the heat transmission capability from this point. This indicates that all the food throughout its bulk has been cooled passed the maximum ice crystal generation zone.

From FIG. 4, the relationship between the interior environment temperature of the freezer 106 and the surface and the core temperatures of the food being frozen, can easily be estimated. Additionally, the amount of conduction between the surface of the food and the core can also be calculated. Accordingly, the present invention can be configured to estimate the temperature of the food from the measured interior environment temperature, in lieu of measuring the temperature of the food directly. For example, control unit 104 may be programmed with an algorithm for calculating estimated surface and core temperatures of the food from the interior temperature of the freezer based on, for example, the curves of FIG. 4. From these estimated temperatures, the control unit 104 can control the variable cooling 112, adjustment unit 110 and fans 116 to cool the food at the proper rate.

A dotted line curve in FIG. 4 shows an example of the temperature drop when variable cooling in the form of carbon dioxide gas is injected into the interior of the freezer.

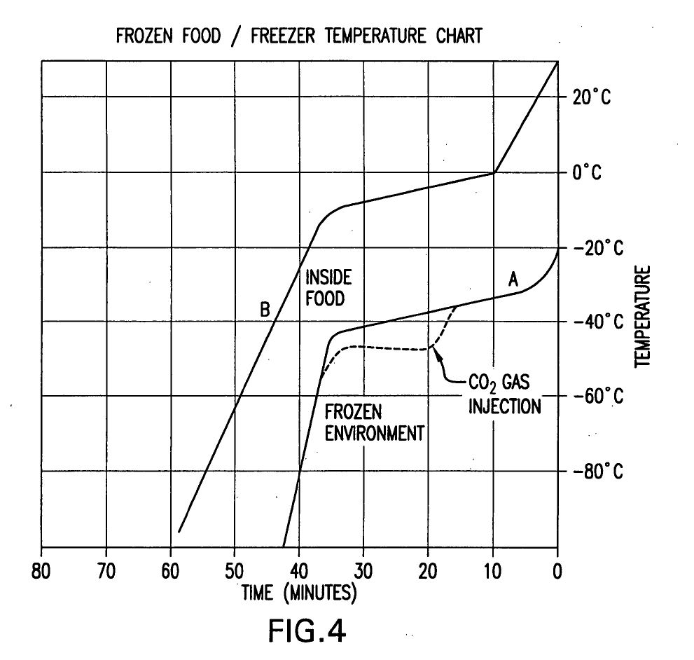

FIG. 5 is a flow diagram of a method for freezing food according to an embodiment of the present invention. First, at step 5-1, the food to be frozen is packaged. In a preferred embodiment, the food is de-aerated and vacuum bagged, shrink wrapped or the like, when the food reaches room temperature or approximately 22° C. Then, at step 5-2, the food is placed in the freezer to begin the freezing process. In a preferred embodiment, the food is at room temperature, approximately 22° C., when placed in the freezer. In an alternative embodiment, the food is placed in the freezer at a temperature at which it is cooked (i.e. 60-80° C). For sushi, the food is frozen preferably within 1-2 hours after the rice is cooked. The food to be frozen can be packed as described above and placed in the freezer 106 of systems 100-300 to begin the freezing process.

At step 5-3, the temperature inside the freezer 106 is measured via temperature sensors 118. As described above, the temperature of the food (surface and/or core) may be estimated using a temperature inclination of the atmospheric temperature from the chart of FIG. 4. Alternatively, temperature sensors 118 may be used to measure the temperature of the food directly.

When the temperature of the food 114 reaches the upper limit of the accelerated aging temperature zone (e.g., for sushi, approximately 10° C.), a cooling pattern is generated to cool the food through the accelerated aging temperature zone. For example, the control unit 104 controls the adjustment unit 110 and the fans 116 to create an operative cooling pattern (i.e., the fans blow air over the dry ice). Control unit 104 may also initiate variable cooling via variable cooling units 112, if cooling is too slow. Variable cooling injection then can be combined with circulation control by the control unit 104, and the temperature of the food is decreased through the accelerated aging zone at the appropriate rate. Preferably, the temperature of the food is reduced quickly to properly freeze the food throughout its bulk without damage to the food cells. Preferably, the accelerated aging temperature zone (approximately 6° C. to about 0° C.) is traversed in 1-10 minutes, and preferably 3-5 minutes.

At step 5-4, when temperature of the surface of the food reaches the upper limit of the ice crystal generation zone (e.g., for sushi ˜0° C.), variable cooling is adjusted again, if necessary, in response to heat transmission of the food. Variable cooling may be terminated if the temperature of interior freezer 106 is sufficient to continue cooling of the food through the ice crystal generation zone at an adequate rate and to prevent the food from cooling too quickly. Variable cooling may not be necessary to freeze food at the proper rate. If the temperature of the food does not reach approximately −5° C. to approximately −7° C. within approximately 10-15 minutes after the food is introduced into the freezer, variable cooling may be initiated to force the temperature to go down momentarily as shown with the dotted line of curve A in FIG. 4, as an example to assure that the temperature of the food decreases to the desired range. One skilled in the art will understand that cooling may necessarily require adjusting based on factors such as the size of the freezer, the amount of food to be frozen at a time, etc.

The food is cooled from 0° C. to −10° C. in approximately 10 to approximately 40 minutes. The food is preferably cooled from 0° C. to −10° C. in approximately 15 to approximately 30 minutes. In another preferred embodiment, the food is cooled from 0° C. to −7° C. in approximately 10 to approximately 40 minutes.

Next, the food is preferably cooled from about −10° C. to about −30° C. within approximately 30 minutes to approximately 90 minutes. The food is more preferably cooled from about −10° C. to about −30° C. within approximately 40 to 60 minutes. By the time the food reaches −30° C., the fans will most likely become unnecessary and may be shut off. At this temperature, the water inside the food is frozen completely.

Next, the food is cooled to about −60° C., in order to freeze composite water that may exist, such as water mixed with oil. Preferably, the food is cooled to −60° C. in approximately 5 to approximately 50 additional minutes. More preferably, the food is cooled to −60° C. in approximately 10 to approximately 30 additional minutes. At this point, the food is completely frozen throughout.

The velocity of coolant circulated in the freezer, such as by a fan, is preferably set to be proportional to the heat transmission efficiency. It is considered that the stronger the velocity of the coolant, the better the heat exchange rate is. However, the velocity of the coolant in the freezer shall be controlled in consideration of the whirlpool motion of air circulating therein and the proper heat exchange in the relation between the flow and the obstruction.

As for the variable cooling, liquid nitrogen and a liquid carbon dioxide can be considered as a coolant. From the aspect of the evaporation temperature and the evaporation latent heat, the nitrogen has −196° C./47 Kcal and carbon dioxide has −78.9° C./137 Kcal. A coolant which has more evaporation latent heat within the range of −60° C. is most suitable. Carbon dioxide gas is preferred.

Temperatures and times described herein are described in connection with preferred embodiments. One skilled in the art will understand that the temperatures and times may differ based on the composition of the food, the size and type of the freezer, etc.

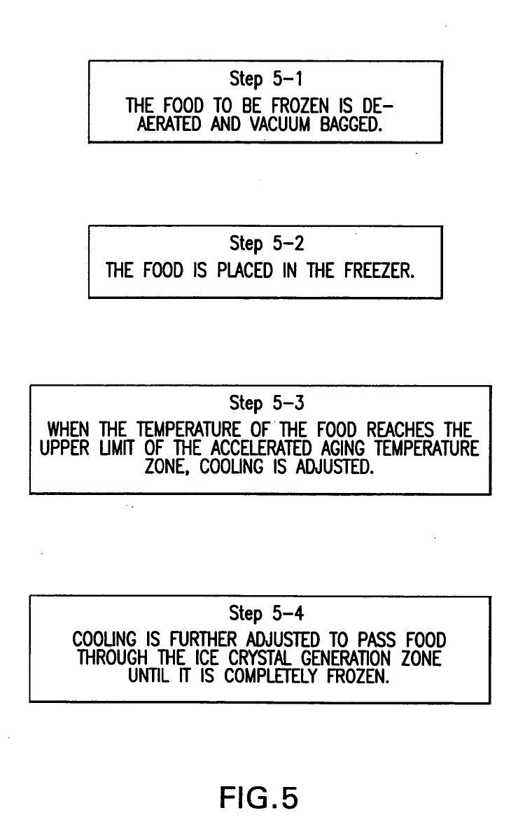

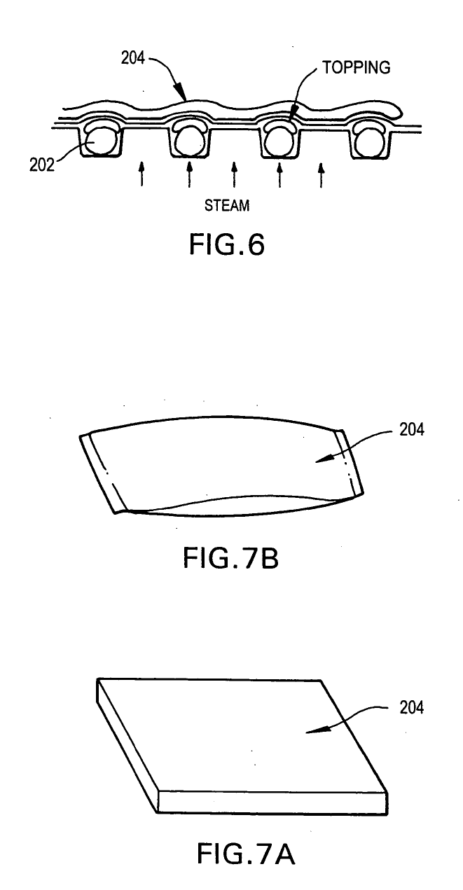

In accordance with another aspect of the present invention, a system and method for thawing frozen food is described with reference to FIGS. 6, 7A and 7B. When thawing a container of vacuum packed frozen food 202, such as sushi, a container of a solution or gel 204 is placed on top of package of the food. In the case of sushi, container 204 is placed on the side of the sushi topping. Preferably, the container 204 is flexible, like a bag, to allow good surface contact with the food 202. The cooling solution in the bag 204 should preferably fit any contour of the frozen food container 202 (water, gel, jelly, etc.).

As illustrated in FIG. 6, the food can be thawed conventionally with a steamer, with the heating energy applied to the bottom of the frozen food container. The cooling solution 204 on top of the food 202 allows, in the case of sushi, the rice portion to be defrosted to a slightly warm condition while topping (raw fish, etc.) is maintained in chilled condition by the cooling solution on top. Thus, the present invention provides a very inexpensive method for defrosting food that can be performed by anyone and at any volume.

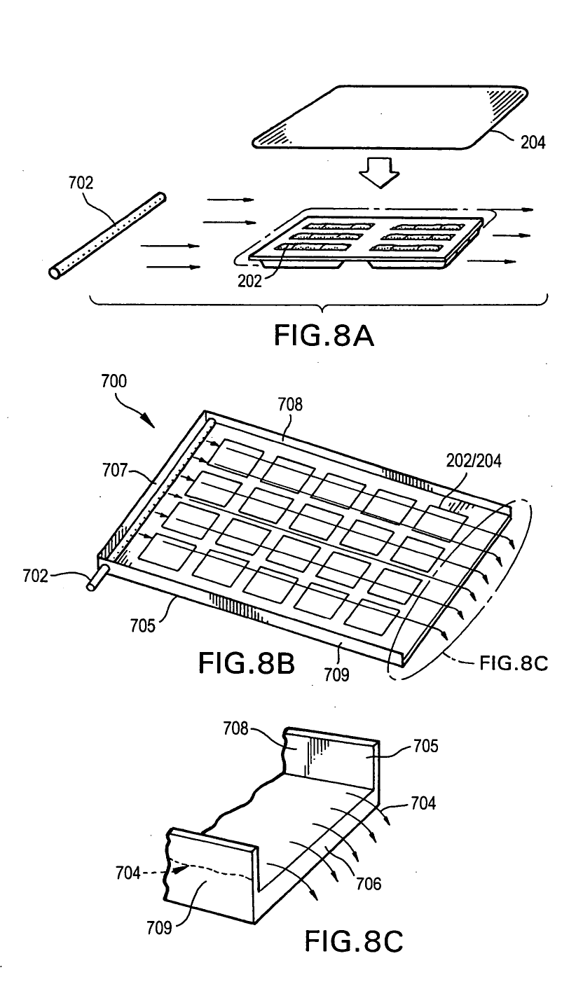

Another embodiment of the present invention is shown in FIGS. 8A-8C. System 700 is a warm water thawing system that includes a tray 705 and a water source 702. The tray 705 may be disposed at an angle to allow gravity assist with water flow. The tray has three sides or lips 707-709 and a fourth side 706 is left open to allow the water to drain from the tray. As illustrated in FIG. 8A, frozen food 202 is preferably arranged in the tray such that water from source 702 flows under and along the sides of the food 202.

Similar to the method described with reference to FIG. 6, a cooling pack 204 is preferably placed on top of the frozen food containers 202. For sushi, this keeps the topping cool while the rice side is warmed by the water. The water may be at any appropriate temperature to thaw the food at the desired rate such as, for example, approximately 60° C. to 90° C. and preferably 60° C. to 80° C. The water level is preferably controlled so that the warm water does not reach the topping side of the sushi. The food is preferably thawed in approximately 5 to 45 minutes, more preferably thawed in approximately 10 to 20 minutes, and most preferably thawed in approximately 10 to 15 minutes.

With the system 700, a large volume of frozen food may be thawed at the same time.

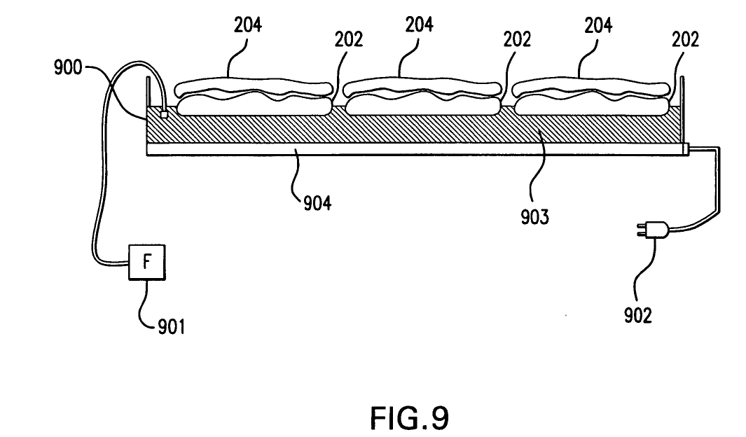

FIG. 9 illustrates another system for thawing food products in accordance with another embodiment of the present invention. In particular, FIG. 9 discloses a device 900 for containing a medium 903 for thawing the food product, such as sushi. The device 900 can be any suitable device for containing the medium 903, such as a container or tray. In a preferred embodiment, the device 900 includes a means for heating the contents of the device. The means for heating can be any suitable means for heating the contents of the device such as an electrical heating element 904. Electrical heating element 904 can be connected to any suitable power source, such an electrical outlet, via plug 902. In a preferred embodiment, the medium 903 is water. Medium 903 could also be any suitable heat conducting medium.

As illustrated in FIG. 9, the food product 202 is placed in the device 900 with the cooling pack 204 preferably placed on top of the food 202. Medium 903, such as water, is also placed in the device 900 and is heated to a temperature which is desired to thaw the food product 202. In a preferred embodiment, the level of medium 903 in the device 900 is controlled so that it does not reach the topping side of the food product 202, such as sushi. Also in accordance with a preferred embodiment, a temperature sensor 901 can be used to monitor and control the temperature of the medium 903 in the device 900.

Thus, the invention has been described in connection with what are presently considered to be the most practical and preferred embodiments. It is to be understood that the invention is not to be limited to the disclosed embodiments, but, on the contrary, is intended to cover various modifications and equivalent arrangements included within the spirit and scope of the appended claims.

1. A method of freezing food for later thawing and use, said method comprising steps of:
(1) cooling the food product substantially throughout the bulk thereof to approximately 10° C. to 0° C. in approximately 1 to 10 minutes; and
(2) cooling the food product substantially throughout the bulk thereof to approximately 0° C. to −10° C. in approximately 10 to 40 minutes.

2. The method as recited in claim 1, wherein the food product is cooled to approximately 6° C. to 0° C. in approximately 1 to 10 minutes.

3. The method as recited in claim 1, wherein the food product is cooled to approximately 0° C. to −7° C. in approximately 10 to 40 minutes.

4. The method as recited in claim 1, wherein the food product is cooled to approximately 10° C. to 0° C. in approximately 3 to 5 minutes.

5. The method as recited in claim 1, wherein the food product is cooled to approximately 0° C. to −10° C. in approximately 15 to 30 minutes.

6. The method as recited in claim 3, wherein the food product is cooled to approximately 0° C. to −70° C. in approximately 15 to 30 minutes.

7. The method as recited in claim 2, wherein the food product is cooled to approximately 6° C. to 0° C. in approximately 3 to 5 minutes.

8. The method as recited in claim 1, wherein cooling step (2) is performed at a substantially steady rate.

9. The method as recited in claim 1, wherein said food product is sushi.

10. The method as recited in claim 1, further comprising packing the food product in a container for freezing.

11. The method as recited in claim 4, wherein said packing step includes vacuum bagging said food product.

12. The method as recited in claim 1, wherein the cooling step (2) includes steps of:
(a) placing the food product after it is packaged into a freezer having an ambient temperature of approximately −40° C. to −70° C. and a variable cooling feature;
(b) adjusting said variable cooling feature to ensure the food product is cooled substantially throughout the bulk thereof from about 10° C. to about −10° C. in less than approximately 40 minutes; and
(c) removing said food product from said freezer after the temperature of said food product reaches a predetermined temperature that is lower than approximately −10° C.

13. The method as recited in claim 12, wherein the adjusting step (b) includes controlling a circulation of air within said freezer.

14. The method as recited in claim 12, wherein the adjusting step (b) includes directing a supply of liquid carbon dioxide into said freezer.

15. The method as recited in claim 12, wherein the adjusting step (b) includes controlling an incident angle between dry ice in said freezer and a circulation of air within said freezer.

16. The method as recited in claim 14, wherein the supply of liquid carbon dioxide is terminated when the temperature of said food product reaches approximately −5° C. −7° C.

17. A method of freezing a food product, said method comprising steps of:
(1) packaging a food product to be frozen after a temperature of said food product reaches a first predetermined temperature;
(2) cooling said food product until the temperature of said food product reaches a second predetermined temperature; and
(3) cooling said food product so that the temperature of said food product decreases from said second predetermined temperature to a third predetermined temperature within a first predetermined period of time.

18. The method as recited in claim 17, wherein said second predetermined temperature and said third predetermined temperature are selected to define a temperature range wherein said food product is subject to at least one of accelerated aging and maximum ice crystallization generation.

19. The method as recited in claim 17, wherein said first period of time is selected to minimize at least one of aging and ice crystallization generation of said food product during said cooling step (3).

20. The method as recited in claim 17, wherein a fourth predetermined temperature is selected between said second and third predetermined temperatures such that said second and fourth predetermined temperatures define a temperature range wherein said food product is subject to accelerated aging and the third and fourth predetermined temperatures define a temperature range wherein said food product is subject to maximum ice crystallization generation, said first period of time is divided into second and third periods of time, said second period of time corresponding to the amount of time the temperature of said food product will be within said temperature range wherein said food product is subject to accelerated aging, said third period of time corresponding to the amount of time the temperature of said food product will be within said temperature range wherein said food product is subject to maximum ice crystallization generation, and said second and third periods of time are selected to minimize respective aging and ice crystallization generation of said food product during said cooling step (3).

21. The method as recited in claim 17, wherein said first predetermined temperature is approximately 15° C. to 40° C.

22. The method as recited in claim 17, wherein said second predetermined temperature is approximately 10° C. to 0° C.

23. The method as recited in claim 17, wherein said third predetermined temperature is approximately 0° C. to −10° C.

24. The method as recited in claim 17, wherein said first predetermined period of time is approximately 10 to 40 minutes.

25. The method as recited in claim 22, wherein said second predetermined temperature is approximately 6° C. to 0° C.

26. The method as recited in claim 23, wherein said third predetermined temperature is approximately 0° C. to −7° C.

27. The method as recited in claim 24, wherein said first predetermined period of time is approximately 15 to 30 minutes.

28. The method as recited in claim 17, wherein said second predetermined temperature is reached in approximately 1 to 10 minutes.

29. The method as recited in claim 28, wherein said second predetermined temperature is reached in approximately 3 to 5 minutes.

30. A system for freezing food, comprising:
a first freezer maintaining an interior temperature set to a first temperature and including a first cooling unit and a adjustable cooling unit providing additional cooling energy; and
a control unit coupled with said first cooling unit and said adjustable cooling unit and configured to adjust the cooling energy of said adjustable cooling unit.

31. The system as recited in claim 30, wherein said control unit is configured to adjust said adjustable cooling unit to cool a food product placed within said first freezer substantially throughout the bulk thereof from about 10° C. to about −10° C. in approximately 40 minutes.

32. The system as recited in claim 31, wherein said control unit is configured to adjust said adjustable cooling unit to cool said food product at a substantially steady rate.

33. The system as recited in claim 30, wherein said control unit is configured to adjust said first cooling unit and said adjustable cooling unit to cool said food product substantially throughout the bulk thereof from approximately 10° C. to 0° C. in approximately 1 to 10 minutes.

34. The system as recited in claim 30, wherein said control unit is configured to adjust said first cooling unit and said adjustable cooling unit to cool said food product substantially throughout the bulk thereof from approximately 0° C. to −10° C. in approximately 10 to 40 minutes.

35. The system as recited in claim 30, wherein said control unit is configured to adjust said first cooling unit and said adjustable cooling unit to cool said food product substantially throughout the bulk thereof from approximately 0° C. to −6° C. in approximately 15 to 30 minutes.

36. The system as recited in claim 30, wherein said food product is vacuum packed sushi in the form of rolls.

37. The system as recited in claim 30, wherein said adjustable cooling unit includes fans for controlling a circulation of air within said second freezer.

38. The system as recited in claim 15, wherein said first cooling unit includes at least one dry ice block.

39. The system as recited in claim 15, further comprising at least one temperature sensor disposed within said first freezer and communicating with said control unit.

40. The system as recited in claim 39, wherein said at least one temperature sensor measures a surface temperature of food to be frozen placed inside of said first freezer, and said control unit is configured to adjust said variable cooling in response to said surface temperature.

41. The system as recited in claim 39, wherein said at least one temperature sensor measures an environment temperature of said first freezer, and said control unit is configured to adjust said variable cooling in response to said environment temperature.

42. The system as recited in claim 39, wherein said at least one temperature sensor measures a core temperature of food to be frozen, and said control unit is configured to adjust said variable cooling in response to said core temperature.

43. The system as recited in claim 30, wherein said adjustable cooling unit includes at least one liquid carbon dioxide injection unit.

44. The system as recited in claim 30, wherein said adjustable cooling unit includes at least one liquid nitrogen injection unit.

45. The system as recited in claim 30, further comprising a load lock mechanism for preventing loss of cooling energy during loading and unloading of food to be frozen.

46. The system as recited in claim 30, further comprising a second freezer encasing said first freezer, and wherein the interior temperature of said second freezer is maintained to prevent loss of cooling energy in said first freezer during loading and unloading of food to be frozen.

47. The system as recited in claim 45, further comprising a conveyor structure for continuous loading and unload of food to be frozen is said freezer.

48. A method of thawing frozen food, comprising steps of:
placing a coolant source on a side of said frozen food; and
supplying a heat source to a side of said frozen food opposite of said coolant source until said food is thawed to a desired temperature.

49. The method recited in claim 48, wherein said food is sushi.

50. The method recited in claim 49, wherein said coolant source is placed on a topping side of said sushi, said heat source is applied to a bottom side until rice of said sushi is heated to a predetermined temperature.

51. The method recited in claim 48, wherein said coolant source is a flexible package containing water.

52. The method recited in claim 48, wherein said coolant source is a flexible package containing a gel.

53. The method recited in claim 48, wherein heat source is steam.

54. The method recited in claim 48, wherein heat source is warm water.

55. A method of thawing frozen food, comprising steps of:
arranging a plurality of containers of frozen food in a tray;
placing a coolant source on a side of each of said frozen food; and
supplying a source of warm water to said tray until said plurality of containers of frozen food is thawed to a desired temperature.

56. The method recited in claim 55, wherein said frozen food is placed in a tray having three side walls and a fourth side, and wherein said fourth side has no sidewalls and provides drainage for said water source.

57. The method recited in claim 55, wherein said food is sushi.

58. The method recited in claim 57, wherein said coolant source is placed on a topping side of said sushi, and said water source thaws the bottom side of said sushi until rice of said sushi is heated to a predetermined temperature.

59. The method recited in claim 55, wherein said coolant source is a flexible package containing water.

60. The method recited in claim 55, wherein said coolant source is a flexible package containing a gel.

61. The method recited in claim 58, wherein a level of water in said tray from said water source is maintained at a level below a top of each of said plurality of containers of frozen food.

62. The method recited in claim 61, wherein the level of water in said tray from said water source is maintained at a level which does not contact the topping side of said sushi.

63. The method recited in claim 55, wherein said frozen food is placed in a tray having four side walls, and wherein the water is contained within said four side walls.
